(19) United States
(12) Patent Application Publication
(10) Pub. No.: US 2014/0254499 A1
(43) Pub. Date: Sep. 11, 2014

(54) TETHERING OF MOBILE WIRELESS DEVICES

(71) Applicants: Vishwa Hassan, Chandler, AZ (US); Bhaskar D. Gowda, Hillsboro, OR (US); Mrigank Shekhar, Camas, WA (US); Manish Dave, Folsom, CA (US); Akshay Chandrasekhar, Bangalore (IN)

(72) Inventors: Vishwa Hassan, Chandler, AZ (US); Bhaskar D. Gowda, Hillsboro, OR (US); Mrigank Shekhar, Camas, WA (US); Manish Dave, Folsom, CA (US); Akshay Chandrasekhar, Bangalore (IN)

(21) Appl. No.: 13/792,693

(22) Filed: Mar. 11, 2013

(51) Int. Cl. H04W 72/02

(52) U.S. Cl. CPC H04W 72/02
USPC 370/329

(57) ABSTRACT

Embodiments of computer-implemented methods, systems, computing devices, and computer-readable media are described herein for tethering of mobile wireless devices. In some embodiments, a computing device configured for tethering may include a processor and a tethering application operated by the processor to associate a first mobile wireless device with a community of mobile wireless devices eligible for tethering to the first mobile device based on eligibility criteria; identify, among the community of mobile devices, a second mobile wireless device to tether with the first mobile device, based on communication information exchange among the mobile wireless devices in the community, including the first mobile device; and based on a result of the identifying, cause the first mobile device to tether to the second mobile device, so as to enable the first mobile device to connect to a wireless communication network via the second mobile device. Other embodiments may be described and claimed.

### FIELD

Embodiments of the present invention relate generally to the technical field of data communication, and more particularly, to network access via a tethered wireless device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Wireless mobile devices may be able to connect to the Internet using various wireless communication technologies, for example, via Global System for Mobile Communications (GSM) or Code Division Multiple Access (CDMA) based networks. Wireless device communication characteristics such as signal strength, available bandwidth, capacity, and others may be a function of several parameters and may not always be constant depending on device and network characteristics, and sometimes may not be sufficient for accomplishing a particular task assigned to the device.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example system in which the techniques for handling mobile wireless device tethering described herein may be practiced, in accordance with some embodiments.

FIG. 2 is a process flow diagram illustrating an example method for handling mobile wireless device tethering, in accordance with various embodiments.

FIG. 3 is a process flow diagram illustrating another example method for handling mobile wireless device tethering, in accordance with various embodiments.

FIG. 4 is a process flow diagram illustrating another example method for handling mobile wireless device tethering, in accordance with various embodiments.

FIG. 5 is a process flow diagram illustrating another example method for handling mobile wireless device tethering, in accordance with various embodiments.

FIG. 6 is a process flow diagram illustrating another example method for handling mobile wireless device tethering, in accordance with various embodiments.

FIG. 7 illustrates an example computing device on which disclosed methods and computer-readable media may be implemented, in accordance with various embodiments.

### DETAILED DESCRIPTION

Embodiments of the present disclosure provide techniques and configurations in a wireless communication network including techniques and configurations for handling tethering of mobile wireless devices operating in one or more wireless communication networks. For example, at any given time, the signal strength available on a mobile device A from a service provider P may be higher than the signal strength available on another mobile device B from a service provider Q. As the internee bandwidth may vary with the signal strength, device A may have a higher bandwidth than device B. Incorporated with the teachings of the present disclosure, mobile device B may use capabilities provided by mobile device A to access the Internet for data transmission, content acquisition, or any other communication task, via service provider P.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure; the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

Example embodiments may be described herein in relation to wireless communication networks including networks such as 3^{rd} Generation Partnership Project (3GPP) Long-Term Evolution (LTE) networks including any amendments, updates, and/or revisions (e.g., LTE Release 10 (also referred to as LTE-Advanced (LTE-A), LTE Release 11, etc.), Worldwide Interoperability for Microwave Access (WiMAX) networks, and the like. In other embodiments, communication schemes described herein may be compatible with additional/alternative communication standards, specifications, and/or protocols. For example, embodiments of the present disclosure may be applied to other types of wireless networks where similar advantages may be obtained. Such networks may include, but are not limited to, wireless local area networks (WLANs), wireless personal area networks (WPANs) and/or wireless wide area networks (WWANs) such as cellular networks and the like.

Techniques described herein provide fir handling mobile wireless device tethering in a wireless network environment. In some embodiments, a mobile wireless device operating in a wireless network environment may be configured to engage in communication information exchange, e.g., communicate to and receive from other mobile wireless devices communication information associated with the devices' ability to communicate with the Internet over the wireless communication network. The communication information may include but may not be limited to signal strength, mobile technology information, available bandwidth, capacity, and the like.

In some embodiments, the mobile wireless device may be further configured to select, based on the provided communication information, another mobile wireless device among the mobile wireless devices, and to tether to the selected mobile wireless device to enable a connection to the Internet via the tethered-to device based on the communication characteristics of the tethered-to mobile wireless device. In some embodiments, the mobile wireless device may be further configured to allow other mobile wireless devices to tether to the mobile wireless device based on the provided communication information, thus enabling the tethered mobile wireless device to access the Internet via the mobile wireless device. The mobile wireless devices configured for communication information exchange and tethering may be identified based on one or more common characteristics, such as common location, common ownership, level of trust, user preferences, common identifier, and the like.

Tethering as referenced herein is ability to connect one wireless device to another, thus allowing sharing the capabilities (e.g., ability to connect to the Internet) of the tethered-to device with the tethered device, without using wired connection with the tethered device. In one example, tethering is an ability to use an Internet-enabled mobile wireless device as a gateway for another, not-Internet-enabled mobile wireless device. Tethering may be accomplished over via device-to-device (D2D) communication technology. D2D communications may be used, e.g., when wireless devices initiate communication with each other while within direct wireless range of each other. D2D communications may be implemented using different platforms, such as 802.111 (“WiFi”), BlueTooth®, near field communication (“NFC”), LTE communication technology, FlashLinq by Qualcomm®, and so forth.

For example, if a mobile wireless device A is Internet-enabled and may communicate with another mobile wireless device B via a D2D communication protocol, the mobile wireless device A may tether to the mobile wireless device B via the D2D communication protocol. When tethered, the mobile wireless device A may have an ability to redirect communications received from the Internet, e.g., via wireless communication network according to a communication protocol (e.g., Hypertext Transfer Protocol (HTTP)), to the tethered device B according to the D2D communication protocol. The mobile wireless device B, when communicating via the tethered device A, may have an ability to route its communications to the device A according to the D2D communication protocol, to be routed by the device A according to a wireless network communication protocol (e.g., HTTP).

In more general terms, the provision of the communication information among the mobile wireless devices may be accomplished using any known technology. For example, mobile wireless devices configured as described above may communicate with each other “indirectly,” e.g., via intermediaries such as base stations over a wireless wide area network (“WWAN”). In some embodiments, mobile wireless devices may be configured to communicate directly with other mobile wireless devices, e.g., via D2D communication technology as described above.

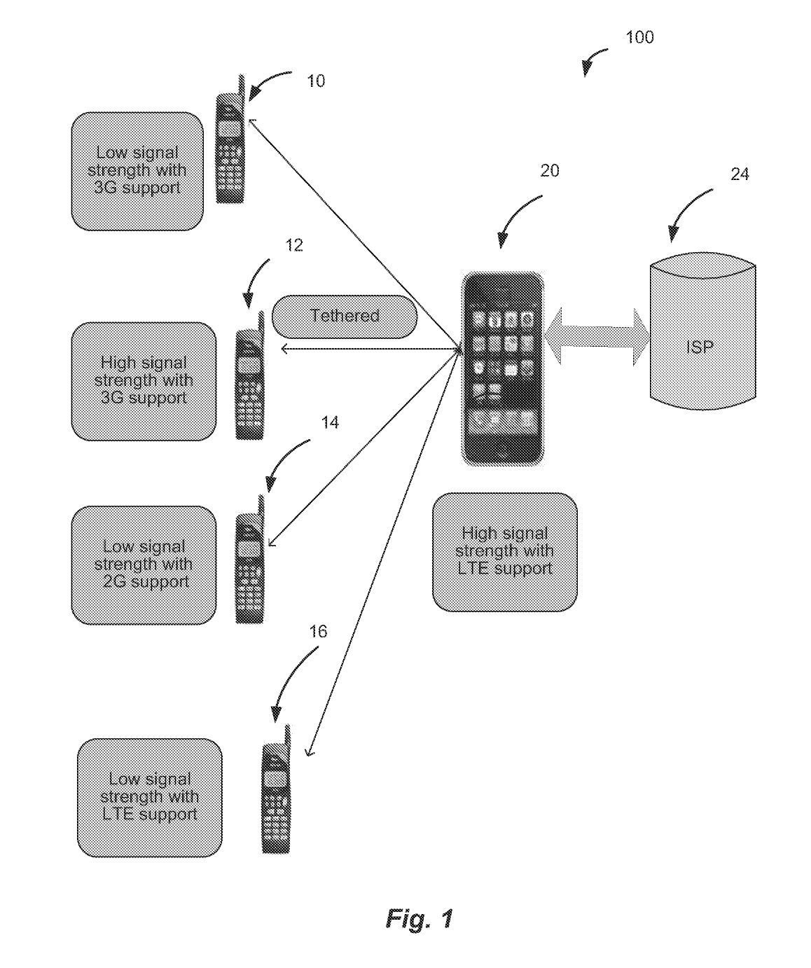

FIG. 1 schematically illustrates an example communication system 100 that may operate on one or more wireless communication networks and in which techniques for providing mobile wireless device tethering described herein may be implemented, in accordance with some embodiments.

At least some of the elements of the system 100 may include mobile wireless devices configured to operate on different wireless technologies, for example, second-generation (2G) wireless network, third-generation (3G) wireless network, or 3^{rd} Generation Partnership Project (3GPP) Long-Term Evolution (LTE) network. For example, the system 100 may include moble wireless devices 10, 12, 14, 16, and 20. Mobile wireless device 20 may be configured to provide high-signal-strength access to the Internet (e.g., provided by an Internet service provider ISP 24) via an LTE network. Mobile wireless device 10 may be configured to operate on a network with lesser capacity or performance than the LIE network, e.g., 3G wireless network, and provide low signal strength (e.g., relative to the signal strength of the device 20). Mobile wireless device 12 may be configured to operate on a 3G wireless network and provide high signal strength (e.g., relative to the signal strength of the device 10). Mobile wireless device 14 may be configured to operate on a 2G wireless network and provide low signal strength (e.g., relative to the signal strength of the device 10). Wireless device 16 may be configured to operate on an LTE wireless network and provide low signal strength (e.g., relative to the signal strength of the device 20).

One or more of the mobile wireless devices 10, 12, 14, 16, 20 may be further configured to communicate with each other, for example, via a D2D communication protocol (e.g., 802.11 (“WiFi”), BlueTooth®, near field communication (“NFC”), FlashLinq, and the like). One or more of the mobile wireless devices 10, 12, 14, 16, and 20 may form a “community” of mobile wireless devices that may be eligible to tether to one another if necessary. The tethering-eligible community may be formed based on one or more tethering eligibility criteria such as, for example, common location, common user (ownership), and the like. The mobile wireless devices in the community may be enabled to send, and receive, communication information associated with each mobile wireless device's communication capability, such as signal strength, available bandwidth, capacity, technology information, and the like.

Assume mobile wireless device 12 is assigned a task associated with accessing the Internet (e.g., accessing content on the Internet or the like). Mobile wireless device 12 may not have the ability to access the Internet or otherwise execute the task in a desirable manner. For example, wireless device 12 may lack an interface to a wireless network providing connection to the Internet, or may have access with inadequate bandwidth, or may have low signal strength and so on. Mobile wireless device 12 may select, among other devices in the tethering-eligible community (e.g., devices 10, 14, 16, and 20), based on the communication information provided to the mobile wireless device 12 by other mobile wireless devices in the community, a mobile wireless device with communication characteristics most suitable for the completion of the assigned task, for example, higher quality of service via the wireless network.

In the illustrated example, mobile wireless device 20 is shown as having high signal strength and the ability to operate in the LTE environment. In other words, mobile wireless device 20's communication capabilities may be superior to those of the other mobile wireless devices available for tethering (10, 14, or 16) and thus most suitable for assisting mobile wireless device 12 in executing the assigned task. For example, mobile wireless device 20 may have signal strength that may be sufficient for the task completion, while mobile wireless device 12 may have insufficient signal strength for the task completion. Accordingly, mobile wireless device 12 may select mobile wireless device 20 for tethering, as shown in FIG. 1, in order to be able to complete the assigned task using the communication capabilities of mobile wireless device 20.

Once tethered to mobile wireless device 20, mobile wireless device 12 may accomplish the task with the assistance of the tethered-to mobile wireless device 20, or delegate the task execution to the tethered-to wireless device 20. Mobile wireless device 12 (or another entity, such as a computing device (not shown) configured to manage the tethering-eligible community of wireless devices 10, 14, 16, and 20) may cancel or deny tethering upon the task completion or upon detecting a tethering-cancellation triggering event. The tethering-cancellation triggering event may include, for example, but not limited to, exceeding of a predetermined data limit capacity by wireless device 20, leaving the tethering-eligible community by mobile wireless device 20 (e.g., leaving a particular area where the community is residing), and the like.

While FIG. 1 generally depicts mobile wireless devices 10, 12, 14, 16, and 20 as mobile phones, in various embodiments, mobile wireless devices 10, 12, 14, 16, and 20 may include a sub-notebook, a notebook, an Ultrabook®, a netbook, a smartphone, an ultra mobile PC (UMPC), a handheld mobile device, an universal integrated circuit card (UICC), a personal digital assistant (PDA), a computing tablet, a portable media player, a portable game player, a digital camera, and the like.

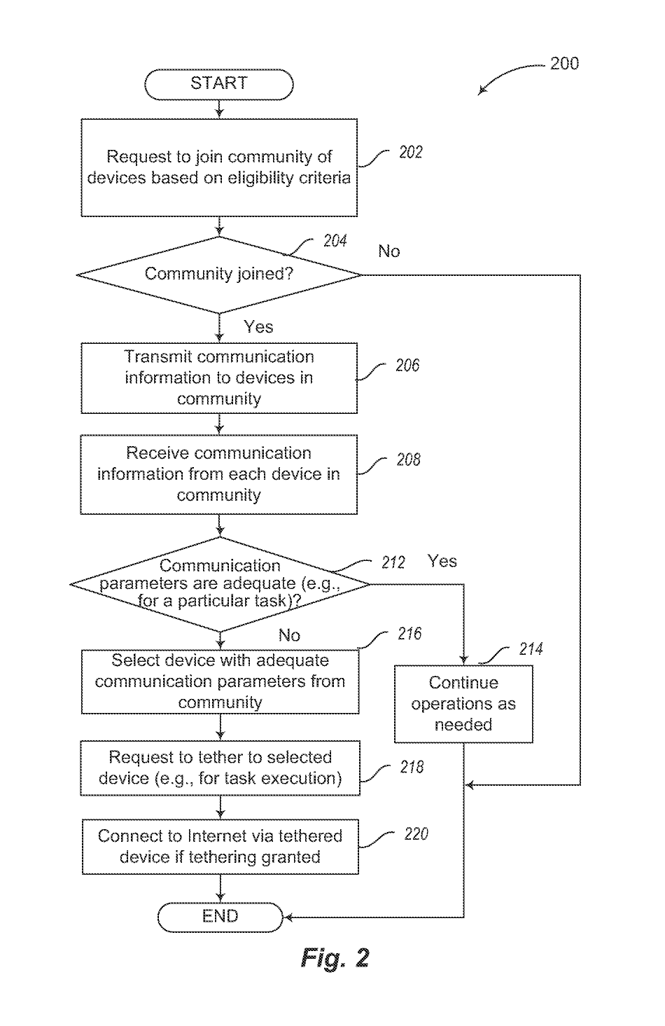

FIG. 2 is a process flow diagram illustrating an example process 200 for tethering of mobile wireless devices, in accordance with various embodiments. The process 200 may be implemented utilizing, for example, system 100 of FIG. 1 described above. The process 200 operations may be performed in various orders other than the order shown, and one or more operations may be added or omitted.

The process 200 may begin at block 202, where a mobile wireless device may provide a request to join a community of mobile wireless devices that are eligible for tethering to one another. As discussed above, the community of mobile wireless devices may be formed based on one or more tethering eligibility criteria, for example, common location, common ownership (e.g., devices belong to, or are operated by, the same user), common identifier (e.g., authentication information that may be common for the community), user preferences that may be common for all devices, and the like. In one example, one or more mobile wireless devices may be located in the same area (e.g., office space) and may be configured for direct D2D communication within the area.

At decision block 204, the mobile wireless device may determine whether the mobile wireless device is allowed to join the community. For example, a mobile wireless device in the community or a computing device configured to manage the community as described in greater detail below may determine whether the mobile wireless device meets the eligibility criteria and provide a corresponding notification to the mobile wireless device. For example, the mobile wireless device may be determined to be located within the same area and may be requested to authenticate with the community.

If it is determined that the requesting mobile wireless device may not meet the eligibility criteria and/or may not be able to authenticate with the community, the process 200 may end. Otherwise, the process may move to block 206, where the mobile wireless device, upon approval of the request to join, may send its communication information, to be received by other devices in the community. The mobile wireless device may provide the communication information upon request from one or more mobile wireless devices or transmit the communication information periodically.

As discussed above, the mobile wireless devices in the community may be configured to communicate with each other and therefore transmit their own communication information to other mobile wireless devices and receive communication information from the other mobile wireless devices. Accordingly, at block 208, the mobile wireless device may receive communication information from one or more (or each) mobile wireless device in the community. In alternate embodiments, the operations at blocks 206 and 208 may be performed (or at least partially performed with some exchanges of communication information) before a decision is made on whether a requesting mobile wireless device is allowed to join the community.

At decision block 212, the mobile wireless device may determine whether its own communication capabilities are adequate, for example, for a completion of a particular task (e.g., accessing content on the Internet). In another example, the mobile wireless device may determine whether there are other devices among the tethering-eligible devices that may provide better connectivity with the Internet, e.g., provide communication capabilities that are superior to the mobile wireless device's own communication capabilities, such as better quality of service, signal strength, broader bandwidth, lower expected cost of connection, and the like. As discussed, the communication capabilities may include different communication parameters, such as data transmission efficiency, data transmission speed, signal strength, available bandwidth, cost of connection, and the like. If the mobile wireless device determines that its own communication capabilities are sufficient or adequate, the mobile wireless device may continue operating as needed, as shown at block 214.

If the mobile wireless device's communication capabilities are determined to be inadequate for one or more tasks to be completed, the mobile wireless device may select, at block 216, among the community of tethering-eligible mobile wireless devices, a mobile wireless device with most suitable communication characteristics. What constitutes most suitable may be application and/or implementation dependent. For example, the mobile wireless device may select another mobile wireless device for tethering based on signal strength. For example, the mobile wireless device may determine that signal strength of another mobile wireless device may be above a predetermined threshold required for the task completion. In another example, the mobile wireless device may determine that another mobile wireless device may provide bandwidth or capacity that is sufficient, or exceeds, a threshold necessary for the task completion.

In yet another example, the mobile wireless device may determine that another mobile wireless device may have capabilities required for the Internet connection, which the mobile wireless device may not have (e.g., the mobile wireless device may have only Wi-Fi capabilities, but not the capabilities to connect to a wide wireless communication network, which another device may provide). In yet another example, the mobile wireless device may determine that another mobile wireless device may provide data capacity that is sufficient, or exceeds, a threshold necessary for the task completion.

When the mobile wireless device selects another mobile wireless device that is suitable for the task completion as discussed in reference to block 216, the mobile wireless device may provide, at block 218, a request for tethering to the selected wireless device. If the selected mobile wireless device allows tethering, the mobile wireless device may tether to the selected mobile wireless device and connect to the Internet via the tethered-to mobile wireless device for the task completion, as indicated by block 220.

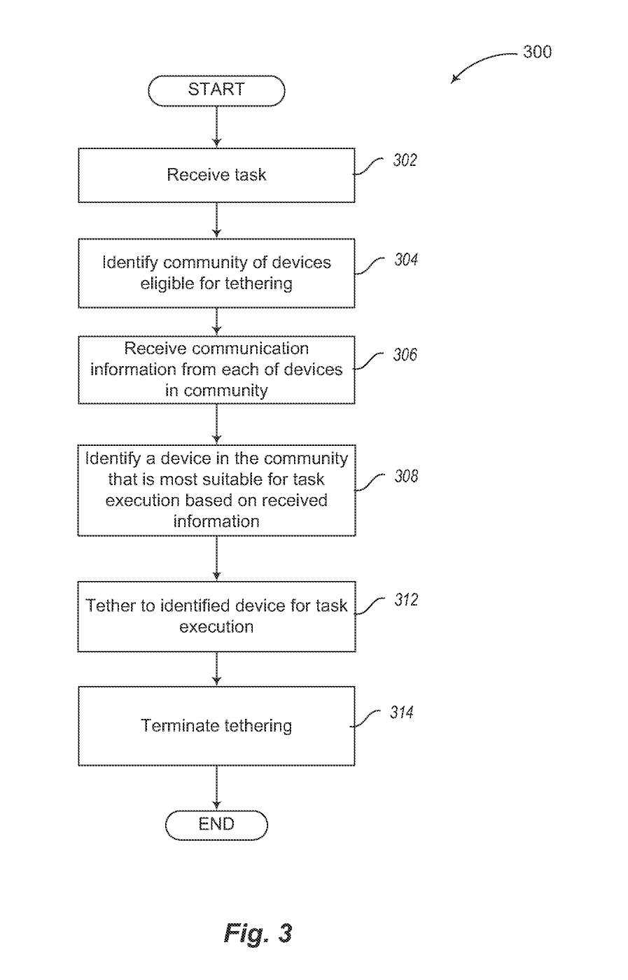

FIG. 3 is a process flow diagram illustrating another example process 300 for tethering of context-based wireless devices, in accordance with various embodiments. The process 300 may be implemented utilizing, for example, system 100 of FIG. 1 described above. The process 300 operations may be performed in various orders other than the order shown, and one or more operations may be added or omitted. The process 300 describes an example in which a mobile wireless device's identifying a community of tethering-eligible mobile wireless devices and subsequent tethering to another tethering-eligible mobile wireless device is triggered by a necessity to complete a particular task assigned to the mobile wireless device.

The process 300 may begin at block 302, where a mobile wireless device may receive a request for a task completion. At block 304, the mobile wireless device may identify one or more mobile wireless devices eligible for tethering in order to complete the requested task. As described in reference to FIG. 2, the eligible mobile wireless devices may be identified based on the tethering eligibility criteria. Other operations of the mobile wireless device may be similar to those described above in reference to FIG. 2. For example, at block 306, the mobile wireless device may receive communication information from the tethering-eligible mobile wireless devices, identify a suitable mobile wireless device at block 308, tether to the identified mobile wireless device at block 312, and terminate or deny tethering at block 314.

In some embodiments, tethering may be terminated or denied upon the task completion. In some embodiments, tethering may be terminated or denied if a particular predetermined value is reached or about to be reached. For example, the data limit related to content accessed by the mobile wireless device may be reached or about to be reached (e.g., data limit may reach a predetermined margin for a certain value). In some embodiments, a warning message may be generated and provided to the user on the mobile wireless device that may inform the user of an upcoming tethering termination. Depending on a user input (e.g., user's approval or overriding termination), the tethering may continue or terminate.

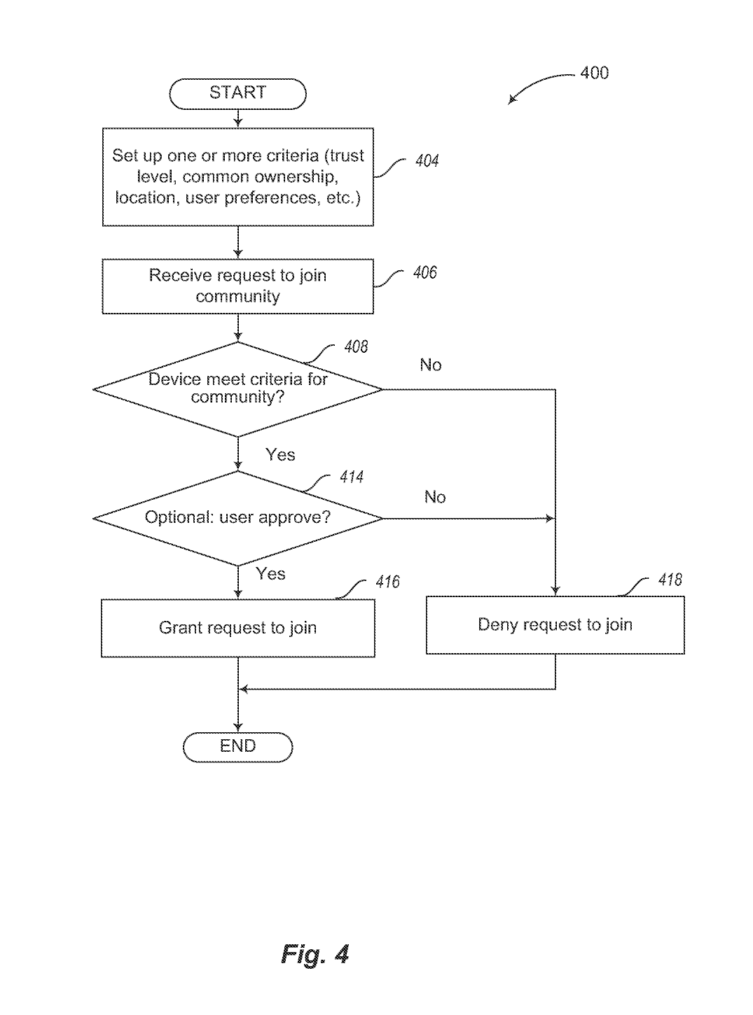

FIG. 4 is a process flow diagram illustrating another example process 400 for tethering of mobile wireless devices, in accordance with various embodiments. The process 400 may be implemented utilizing, for example, system 100 of FIG. 1 described above. The process 400 operations may be performed in various orders other than the order shown, and one or more operations may be added or omitted. The process 400 describes an example of managing a tethering-eligible community of mobile wireless devices. The management of the community may be performed by a management component (e.g., application) hosted by and/or executing on one of the mobile wireless devices—members of the community. In another example, a computing device (e.g., server) may be configured to manage the tethering-eligible community of mobile wireless devices, e.g., by executing a management component hosted by the server or accessible by the server.

The process 400 may begin at block 404, where a community managing component may establish (e.g., identify based on a user input or determine) eligibility criteria on which basis a community of mobile wireless devices may be formed. As discussed above, the eligibility criteria may include, but may not be limited to, common location, common ownership, level of trust, user preferences, common identifier, and the like.

At block 406, the community management component may receive a request from a mobile wireless device to join the community. At decision block 408, the community management component may determine whether the requesting mobile wireless device is eligible to join the community. For example, the community management component may determine that the requesting mobile wireless device is located in a particular area and may be accessible by other mobile wireless devices in the community via, for example, a D2D communication, such as Wi-Fi.

In another example, the community management component may demand that the requesting mobile wireless device authenticate with the community, e.g., provide a password, passphrase or another common identifier. If the community management component determines that the mobile wireless device does not meet eligibility criteria, the community management component may deny the request to join the community at block 418. If the community management component determines that the mobile wireless device meets eligibility criteria, the community management component may optionally determine, at block 414, whether the user approves the mobile wireless device request. If the user does not approve the request, the community management component may deny the request at block 418. If the user approves the request, the community management component may grant the request at block 416.

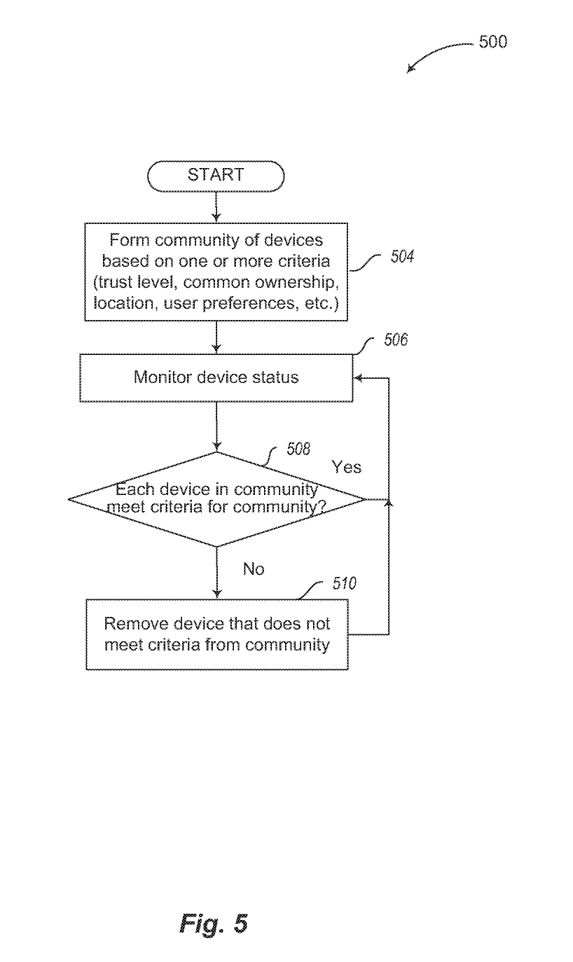

FIG. 5 is a process flow diagram illustrating another example process 300 for tethering of mobile wireless devices, in accordance with various embodiments. The process 500 may be implemented utilizing, for example, system 100 of FIG. 1 described above. The process 500 operations may be performed in various orders other than the order shown, and one or more operations may be added or omitted. The process 500 describes another aspect of managing a tethering-eligible community of mobile wireless devices. As described in reference to FIG. 4, the management of the tethering-eligible community of mobile wireless devices may be executed by a community management component residing on or being accessible by one of the community mobile wireless devices or a remote management server.

The process 500 may begin at block 504, where the community management component may form the community as described above in reference to FIG. 4. For example, the community management component may identify the one or more mobile wireless devices that meet the tethering eligibility criteria. At block 506, the community management component may monitor a status of mobile wireless devices identified as members of the tethering-eligible community. For example, the community management component may periodically (or on-demand) check whether the member devices still meet the tethering eligibility criteria. At decision block 508, the community management component may determine whether each mobile wireless device in the community meets the eligibility criteria. For example, the community management component may monitor the location of the devices or their capability to connect with each other using, for example, D2D communication technology.

In another example, a member mobile wireless device may inform the community management component that the mobile wireless device no longer meets the eligibility criteria. For example, the member mobile wireless device may send a notification to the community management component on a power-off or when the mobile wireless device leaves the designated location. If the community management component determines that all mobile wireless devices meet the eligibility criteria, the community management component may continue monitoring the status of the mobile wireless devices at block 506. If the community management component determines that at least one mobile wireless device no longer meets the eligibility criteria, the community management component may command the mobile wireless device to leave the community or remove the device from the community. For example, the community management component may cancel the mobile wireless device authentication with the community and/or inform other devices of the status change of the mobile wireless device in question.

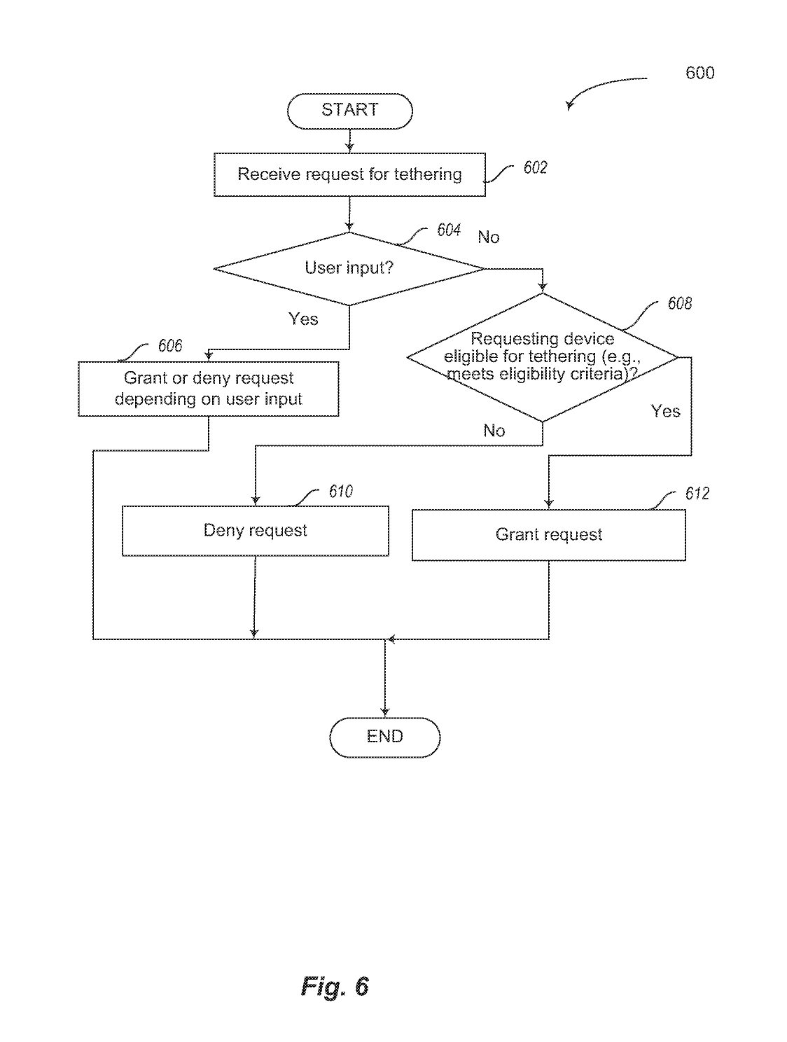

FIG. 6 is a process flow diagram illustrating another example process 600 for tethering of mobile wireless devices, in accordance with various embodiments. The process 600 may be implemented utilizing, for example, system 100 of FIG. 1 described above. The process 600 illustrates an aspect of managing the tethering-eligible community of mobile wireless devices that relates to allowing or denying requests for tethering received by a tethering-eligible mobile wireless device. The process 600 may be performed by a mobile wireless device—member of the tethering-eligible community or by a computing device (e.g., a server) configured to manage tethering-eligible community of mobile wireless devices.

The process 600 may begin at block 602, where a mobile wireless device may receive a request for tethering from another wireless device. At decision block 604, the mobile wireless device may determine whether user input has been received in association with the request. For example, the request may be provided with the user input, e.g., via a user interface of the wireless device.

If the request is associated with the user input, the mobile wireless device may deny or grant request depending on the user input. For example, the user may request that the requesting device tethered to the mobile wireless device. In another example, the user may override a tethering request from the requesting device. If the request is not associated with the user input, the mobile wireless device may determine, at decision block 608, whether the requesting mobile wireless device is eligible for tethering, e.g., whether the mobile wireless device meets tethering eligibility criteria. For example, the mobile wireless device may request that a community manager described in reference to FIGS. 4 and 5 determine the eligibility of the requesting mobile wireless device. Depending on the outcome of this determination, the mobile wireless device may deny the request at block 610 or grant the request at block 612.

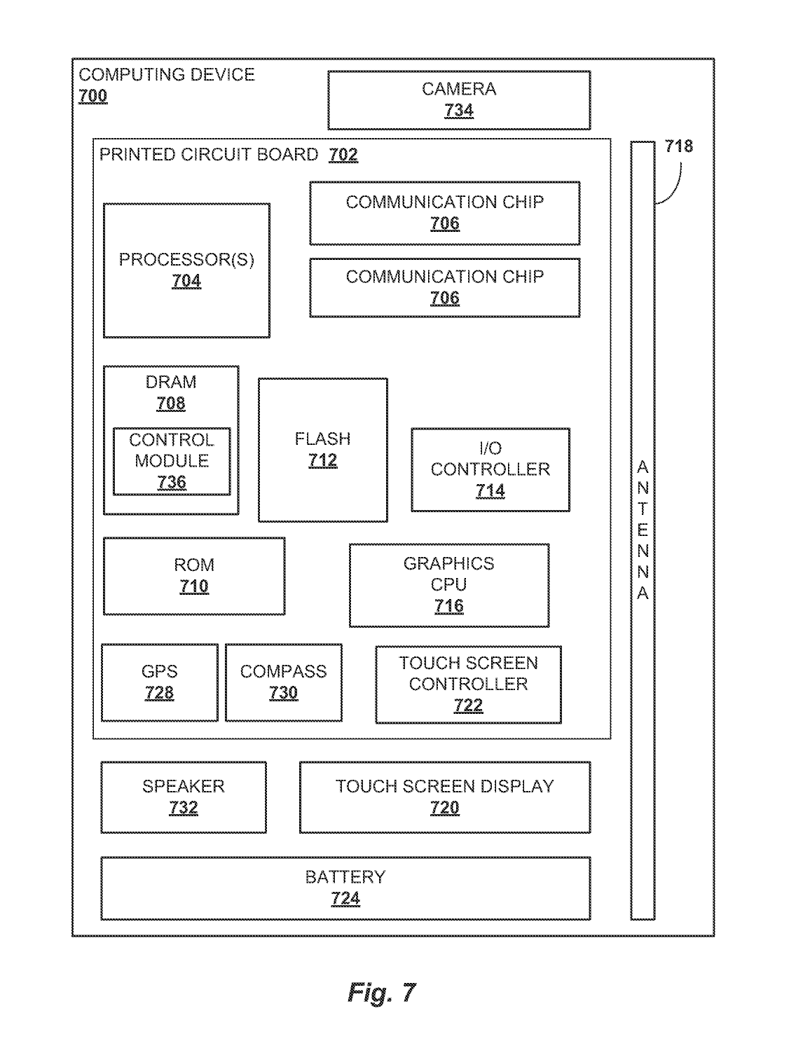

Embodiments of the present disclosure may be implemented into a system (e.g., a computing device) using any suitable hardware and/or software to configure as desired. FIG. 7 illustrates an example computing device 700 that may be used to practice various embodiments described herein. In some embodiments, the computing device 700 may be capable of functioning as a mobile wireless device 10, 12, 14, 16, or 20 as described herein in reference to FIG. 1. Further, the computing device 700 may be configured to perform the processes described above in reference to FIGS. 3-6. For example, the computing device 700 may be capable of executing a community management component as described in reference to FIGS. 4-6, or otherwise provide logic/module that performs processes 300, 400, 500, and 600 described herein.

The computing device 700 may include a number of components, one or more processor(s) 704 and at least one communication chip 706. In various embodiments, the processor 704 may be a processor core. In various embodiments, the at least one communication chip 706 may also be physically and electrically coupled to the processor 704. In further implementations, the communication chip 706 may be part of the processor 704. In various embodiments, computing device 700 may include a printed circuit board (PCB) 702. For these embodiments, processor 704 and communication chip 706 may be disposed thereon. In alternate embodiments, the various components may be coupled without the employment of PCB 702.

Depending on its applications, computing device 700 may include other components that may or may not be physically and electrically coupled to the PCB 702. These other components include, but are not limited to, volatile memory (e.g., dynamic random access memory 708, also referred to as “DRAM”), non-volatile memory (e.g., read only memory 710, also referred to as “ROM”), flash memory 712, an input/output controller 714, a digital signal processor (not shown), a crypto processor (not shown), a graphics processor 716, one or more antenna 718, a display (not shown), a touch screen display 720, a touch screen controller 722, a battery 724, an audio codec (not shown), a video codec (not shown), a global positioning system (“GPS”) device 728, a compass 730, an accelerometer (not shown), a gyroscope (not shown), a speaker 732, a camera 734, and a mass storage device (such as hard disk drive, a solid state drive, compact disk (“CD”), digital versatile disk (“DVD”)) (not shown), and so forth. In various embodiments, the processor 704 may be integrated on the same die with other components to form a System on Chip (“SoC”).

In various embodiments, volatile memory (e.g., DRAM 708), non-volatile memory (e.g., ROM 710), flash memory 712, and the mass storage device may include programming instructions configured to enable computing device 700, in response to execution by processor(s) 704, to practice all or selected aspects of methods 200, 300, 400, 500, or 600. For example, one or more of the memory components such as volatile memory (e.g., DRAM 708), non-volatile memory (e.g., ROM 710), flash memory 712, and the mass storage device may include temporal and/or persistent copies of instructions that, when executed, enable computing device 700 to operate a control module 736 configured to practice all or selected aspects of methods 200, 300, 400, 500, or 600.

The communication chips 706 may enable wired and/or wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Most of the embodiments described herein may include D2D protocols, like WiFi and others described above. However, the communication chip 706 may additionally implement any of a number of wireless standards or protocols, including but not limited to IEEE 702.20, General Packet Radio Service (“GPRS”), Evolution Data Optimized (“Ev-DO”), Evolved High Speed Packet Access (“HSPA+”), Evolved High Speed Downlink Packet Access (“HSDPA+”), Evolved High Speed Uplink Packet Access (“HSUPA+”), Global System for Mobile Communications (“GSM”), Enhanced Data rates for GSM Evolution (“EDGE”), Code Division Multiple Access (“CDMA”), Time Division Multiple Access (“TDMA”), Digital Enhanced Cordless Telecommunications (“DECT”), Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others.

In various implementations, the computing device 700 may be a laptop, a netbook, a notebook, a sub-notebook, an Ultrabook®, a smartphone, a computing tablet, a personal digital assistant (“PDA”), an ultra mobile PC, a mobile phone, a desktop computer, a server, a printer, a scanner, a monitor, a set-top box, an entertainment control unit (e.g., a gaming console), a digital camera, a portable music player, a portable media player, a portable game device, a portable personal digital assistant, a digital video recorder, and the like. In further implementations, the computing device 700 may be any other electronic device that processes data.

Various embodiments described herein include computing device comprising a processor and a tethering application configured to be operated by the processor to associate a first mobile wireless device with a community of mobile wireless devices eligible for tethering to one another, based at least in part on one or more eligibility criteria and identify, for the first mobile wireless device, among the community of mobile wireless devices, a second mobile wireless device to tether with the first mobile wireless device, wherein the identification may be based on communication information exchanged among the mobile wireless devices in the community, including the first mobile wireless device. Based on a result of the identification, the application may cause the first mobile wireless device to tether to the second mobile wireless device, so as to enable the first mobile wireless device to connect to the wireless communication network via the second mobile wireless device. The communication information may include one or more indicators of quality of service over a wireless communication network.

The first mobile wireless device may be hosted by the computing device and the tethering application may be hosted by the first mobile wireless device. The first mobile wireless device may be one of a smartphone, an Ultrabook®, a sub-notebook, a laptop computer, or a computing tablet, and the second mobile wireless device is also one of a smartphone, on Ultrabook®, a sub-notebook, a laptop computer, or a computing tablet. The wireless communication network may include one of a second-generation (2G) wireless network, third-generation (3G) wireless network, or 3^{rd} Generation Partnership Project (3GPP) Long-Term Evolution (LTE) network configured to provide connectivity with the Internet for the tethered first and second wireless devices. The wireless communication network may be a first wireless communication network, and the first mobile wireless device may have access to a second wireless communication network with lesser capability or performance than the first wireless communication network.

The tethering application may be configured to tether the first mobile wireless device to the second mobile wireless device via a device-to-device (D2D) communication protocol. The D2D communication protocol may include one of Bluetooth®, near field communication (NFC), Long Term Evolution (LTE) communication, or FlashLinq.

The second mobile wireless device may be associated with the community of wireless devices. The eligibility criteria may include at least one of: level of trust, location, user preferences, or common identifier. The tethering application may be configured to cause the first mobile wireless device to join the community of mobile wireless devices, wherein joining the community may initiate the communication information exchanges between the devices of the community and the first mobile device.

The tethering application may be configured to facilitate the communication information exchanges, including transmission of communication information associated with an ability of the first mobile wireless device to communicate over the wireless communication network, wherein each mobile wireless device in the community of mobile wireless devices may be configured to exchange the communication information via, a device-to-device (D2D) communication protocol. The tethering application may be configured to facilitate the communication information exchange, including receipt of communication information associated with communications over the wireless communication network from the community of mobile wireless devices, wherein the communication information received may include communication information received from the second mobile wireless device. The tethering application may be further configured to determine whether the communication information received from each of the community of mobile wireless devices meets one or more communication criteria associated with communicating via the wireless communication network and select the second mobile wireless device based at least in part on a result of the determination.

The described embodiments may include computing device-readable medium comprising instructions stored thereon wherein the instructions, in response to execution by a computing device, may cause the computing device to: receive a request for tethering from another computing device and determine whether to tether to that another computing device. The another computing device may be enabled, via tethering with the computing device, to connect to the Internet via a wireless communication network on which the computing device is operating. The request for tethering from the another computing device may be based at least in part on communication information received at the another computing device, where the communication information may be associated with an ability of the computing device to communicate via the wireless communication network. The computing device and the another computing device may include mobile wireless devices configured to communicate via a device-to-device (D2D) communication protocol.

The instructions that cause the computing device to determine whether to tether to the another computing device may further cause the computing device, in response to execution on the computing device, to determine whether the another computing device is eligible for tethering. The instructions that cause the computing device to determine whether the another computing device may be eligible for tethering, in response to execution on the computing device, may further cause the computing device to transmit the communication information associated with the ability of the computing device to communicate via the wireless communication network, wherein the another computing device may be configured to receive the communication information, and determine that the another computing device complies with tethering eligibility criteria. The instructions that cause the computing device to determine whether to tether to the another computing device may further cause the computing device, in response to execution on the computing device, to determine whether the request from the another computing device is associated with user input, and determine, based on the user input, whether to tether to the another computing device if the request is associated with the user input.

The described embodiments may further include computer-implemented method, that may comprise: receiving, by a first mobile wireless device, a request to perform a task; determining, by the first mobile wireless device, whether performance of the task requires access to a wireless communication network with particular capability or performance not accessible to the first mobile wireless device without tethering with a second mobile wireless device; identifying, by the first mobile wireless device, the second mobile wireless device that is eligible for tethering to provide the first mobile wireless device with the access to the wireless communication network; and tethering, by the first mobile wireless device, to the second mobile wireless device. The tethering may enable the first mobile wireless device to perform the task via a connection with the wireless communication network through the second mobile wireless device.

The identifying the second mobile wireless device that is eligible for tethering may include: identifying, by the first mobile wireless device, one or more other mobile wireless devices that are eligible for tethering based on a tethering eligibility criteria; receiving, by the first mobile wireless device, from each of the one or more other mobile wireless devices, communication information associated with ability to connect to the wireless communication network; and identifying, by the first mobile wireless device, the second mobile wireless device, among the one or more other mobile wireless devices, based at least in part on the communication information.

The computer-implemented method may further comprise: terminating, by the first mobile wireless device, the tethering, wherein the terminating is triggered by at least one of completion of the task, exceeding of a data limit capacity, or losing eligibility for tethering. The identifying the second mobile wireless device, among the one or more other mobile wireless devices, based at least in part on the communication information may include: determining, by the first mobile wireless device, the communication information that is best suited for the task completion; and identifying, by the first mobile wireless device, the second mobile wireless device based on the identified communication information. The determining the communication information that is best suited for the task completion may include identifying, by the first mobile wireless device, one or more parameters in the communication information that ensure the task completion with at least one characteristics that is higher than a similar characteristics of an expected task completion based on tethering of the first mobile wireless device with any other of the one or more mobile wireless devices, wherein the characteristics may include at least one of: a speed of the task completion or a time of the task completion. The first and second mobile wireless devices may be configured to communicate via a device-to-device (D2D) communication protocol. The method may further include completing the task by the first wireless device, wherein the completing of the task may be accomplished by performing the task by the first wireless device or delegating the task by the first wireless device to the second wireless device for performance.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. A computing device comprising:
a processor; and
a tethering application configured to be operated by the processor to:
associate a first mobile wireless device with a community of mobile wireless devices eligible for tethering to one another, based at least in part on one or more eligibility criteria;
identify, for the first mobile wireless device, among the community of mobile wireless devices, a second mobile wireless device to tether with the first mobile wireless device, wherein the identification is based on communication information exchanged among the mobile wireless devices in the community, including the first mobile wireless device, the communication information including one or more indicators of quality of service over a wireless communication network; and
based on a result of the identification, cause the first mobile wireless device to tether to the second mobile wireless device, so as to enable the first mobile wireless device to connect to the wireless communication network via the second mobile wireless device.

2. The computing device of claim 1, wherein the first mobile wireless device is hosted by the computing device and the tethering application is hosted by the first mobile wireless device.

3. The computing device of claim 2, wherein the first mobile wireless device is one of a smartphone, an Ultrabook®, a sub-notebook, a laptop computer, or a computing tablet, and the second mobile wireless device is also one of a smartphone, an Ultrabook®, a sub-notebook, a laptop computer, or a computing tablet.

4. The computing device of claim 1, wherein the wireless communication network is one of a second-generation (2G) wireless network, third-generation (3G) wireless network, or 3^{rd} Generation Partnership Project (3GPP) Long-Term Evolution (LTE) network configured to provide connectivity with the Internet for the tethered first and second wireless devices.

5. The computing device of claim 4, wherein the wireless communication network is a first wireless communication network, and the first mobile wireless device has access to a second wireless communication network with lesser capability or performance than the first wireless communication network.

6. The computing device of claim 1, wherein the tethering application is configured to tether the first mobile wireless device to the second mobile wireless device via a device-to-device (D2D) communication protocol.

7. The computing device of claim 5, wherein the D2D communication protocol includes one of WiFi, Bluetooth®, near field communication (NFC), Long Term Evolution (LTE) communication, or FlashLinq.

8. The computing device of claim 1, wherein the second mobile wireless device is associated with the community of wireless devices.

9. The computing device of claim 1, wherein the eligibility criteria, include at least one of: level of trust, location, user preferences, or common identifier.

10. The computing device of claim 1, wherein the tethering application is configured to cause the first mobile wireless device to join the community of mobile wireless devices, wherein joining the community initiates the communication information exchanges between the devices of the community and the first mobile device.

11. The computing device of claim 10, wherein the tethering application is configured to facilitate the communication information exchanges, including transmission of communication information associated with an ability of the first mobile wireless device to communicate over the wireless communication network, wherein each mobile wireless device in the community of mobile wireless devices is configured to exchange the communication information via a device-to-device (D2D) communication protocol.

12. The computing device of claim 10, wherein the tethering application is configured to facilitate the communication information exchange, including receipt of communication information associated with communications over the wireless communication network from the community of mobile wireless devices, wherein the communication information received includes communication information received from the second mobile wireless device.

13. The computing device of claim 11, wherein the tethering application is further configured to:
determine whether the communication information received from each of the community of mobile wireless devices meets one or more communication criteria associated with communicating via the wireless communication network; and
select the second mobile wireless device based at least in part on a result of the determination.

14. At least one non-transitory computing device-readable medium comprising instructions stored thereon wherein the instructions, in response to execution by a computing device, cause the computing device to:
receive a request for tethering from another computing device; and
determine whether to tether to the another computing device;
wherein the another computing device is enabled, via tethering with the computing device, to connect to the Internet via a wireless communication network on which the computing device is operating, wherein the request for tethering from the another computing device is based at least in part on communication information received at the another computing device, the communication information associated with an ability of the computing device to communicate via the wireless communication network.

15. The at least one non-transitory computing device-readable medium of claim 14, wherein the computing device and the another computing device are mobile wireless devices configured to communicate via a device-to-device (D2D) communication protocol.

16. The at least one non-transitory computing device-readable medium of claim 14, wherein the instructions that cause the computing device to determine whether to tether to the another computing device further cause the computing device, in response to execution on the computing device, to determine whether the another computing device is eligible for tethering.

17. The at least one non-transitory computing device-readable medium of claim 16, wherein the instructions that cause the computing device to determine whether the another computing device is eligible for tethering, in response to execution on the computing device, further cause the computing device to:
transmit the communication information associated with the ability of the computing device to communicate via the wireless communication network, wherein the another computing device is configured to receive the communication information; and
determine that the another computing device complies with tethering eligibility criteria.

18. The at least one non-transitory computing device-readable medium of claim 14, wherein the instructions that cause the computing device to determine whether to tether to the another computing device further cause the computing device, in response to execution on the computing device, to:
determine whether the request from the another computing device is associated with user input; and
determine, based on the user input, whether to tether to the another computing device if the request is associated with the user input.

19. A computer-implemented method, comprising:
receiving, by a first mobile wireless device, a request to perform a task;
determining, by the first mobile wireless device, whether performance of the task requires access to a wireless communication network with particular capability or performance not accessible to the first mobile wireless device without tethering with a second mobile wireless device;
identifying, by the first mobile wireless device, the second mobile wireless device that is eligible for tethering to provide the first mobile wireless device with the access to the wireless communication network; and
tethering, by the first mobile wireless device, to the second mobile wireless device, the tethering enabling the first mobile wireless device to perform the task via a connection with the wireless communication network through the second mobile wireless device.

20. The computer-implemented method of claim 19, wherein the identifying the second mobile wireless device that is eligible for tethering includes:
identifying, by the first mobile wireless device, one or more other mobile wireless devices that are eligible for tethering based on a tethering eligibility criteria;
receiving, by the first mobile wireless device, from each of the one or more other mobile wireless devices, communication information associated with ability to connect to the wireless communication network; and
identifying, by the first mobile wireless device, the second mobile wireless device, among the one or more other mobile wireless devices, based at least in part on the communication information.

21. The computer-implemented method of claim 19, further comprising:
terminating, by the first mobile wireless device, the tethering, wherein the terminating is triggered by at least one of: completion of the task, exceeding of a data limit capacity, or losing eligibility for tethering.

22. The computer-implemented method of claim 19, wherein the connection with the wireless communication network provided by the second mobile wireless device enables the first mobile wireless device to connect to the Internet for the task completion.

23. The computer-implemented method of claim 20, wherein the tethering eligibility criteria include at least one of: level of trust, common ownership, or location and wherein the communication information includes at least one of signal strength, bandwidth, security characteristics, or cost of connection.

24. The computer-implemented method of claim 20, wherein the identifying the second mobile wireless device, among the one or more other mobile wireless devices, based at least in part on the communication information includes:
determining, by the first mobile wireless device, the communication information that is best suited for the task completion; and
identifying, by the first mobile wireless device, the second mobile wireless device based on the identified communication information.

25. The computer-implemented method of claim 24, wherein the determining the communication information that is best suited for the task completion includes identifying, by the first mobile wireless device, one or more parameters in the communication information that ensure the task completion with at least one characteristics that is higher than a similar characteristics of an expected task completion based on tethering of the first mobile wireless device with any other of the one or more mobile wireless devices, wherein the characteristics include at least one of: a speed of the task completion or a time of the task completion.

26. The computer-implemented method of claim 19, wherein the first and second mobile wireless devices are configured to communicate via a device-to-device (D2D) communication protocol.

27. The computer-implemented method of claim 19, further comprising:
completing the task by the first wireless device, wherein the completing of the task is accomplished by performing the task by the first wireless device or delegating the task by the first wireless device to the second wireless device for performance.
